(19) United States
(12) Patent Application Publication
(10) Pub. No.: US 2022/0351405 A1
(43) Pub. Date: Nov. 3, 2022

(54) POSE DETERMINATION METHOD AND DEVICE AND NON-TRANSITORY STORAGE MEDIUM

(71) Applicant: GUANGDONG OPPO MOBILE TELECOMMUNICATIONS CORP., LTD., Dongguan (CN)

(72) Inventors: Yang ZHOU, Palo Alto, CA (US); Jie LIU, Palo Alto, CA (US)

(21) Appl. No.: 17/746,933

(22) Filed: May 17, 2022

Related U.S. Application Data
(63) Continuation of application No. PCT/CN2020/127607, filed on Nov. 9, 2020.
(60) Provisional application No. 62/938,187, filed on Nov. 20, 2019.

(51) Int. Cl. G06T 7/70; G06T 7/50; G06V 10/25; G06V 10/46

(52) U.S. Cl. CPC G06T 7/70; G06T 7/50; G06V 10/25; G06V 10/46

(57) ABSTRACT

Disclosed are a pose determination method and device, and a non-transitory computer storage medium. In the method, plane features of keypoints and depth features of the keypoints are extracted from a first image. Plane coordinates of the keypoints are determined based on the plane features of the keypoints. Depth coordinates of the keypoints are determined based on the depth features of the keypoints. A pose of a region of interest corresponding to the keypoints is determined based on the plane coordinates of the keypoints and the depth coordinates of the keypoints.

### CROSS-REFERENCE TO RELATED APPLICATION(S)

This application is a continuation of International Application No. PCT/CN2020/127607, filed Nov. 9, 2020, which claims priority to U.S. Provisional Application No. 62/938,187, filed Nov. 20, 2019, the entire disclosures of which are incorporated herein by reference.

### TECHNICAL FIELD

The embodiments of the disclosure relate to, but are not limited to, machine learning technologies, and particularly to a pose determination method and device, and a non-transitory computer storage medium storage medium.

### BACKGROUND

With the continuous development of computer vision technology, people begin to pursue a more natural and harmonious way of human-computer interaction. Hand movement is an important channel for human interaction. Human hands can not only express semantic information, but also quantitatively convey spatial direction and location information. This helps to build a more natural and efficient human-computer interaction environment.

The hand is a flexible part of the human body. Compared with other interaction methods, it is more natural to use gestures as a means for human-computer interaction. Therefore, gesture recognition technology is a major research area of human-computer interaction.

### SUMMARY

Embodiments of the disclosure provide a pose determination method and device, and a non-transitory computer storage medium.

In a aspect, a pose determination method is provided, which includes:

extracting, from a first image, plane features of keypoints and depth features of the keypoints;

determining plane coordinates of the keypoints, based on the plane features of the keypoints;

determining depth coordinates of the keypoints, based on the depth features of the keypoints; and

determining, based on the plane coordinates of the keypoints and the depth coordinates of the keypoints, a pose of a region of interest corresponding to the keypoints.

In another aspect, a pose determination device is provided, which includes a memory and a processor. The memory stores a computer program executable on the processor. When executing the program, the processor is caused to implement a pose determination method. In particular, a region of interest is determined from a depth image. Plane features of keypoints and depth features of the keypoints are extracted from the region of interest. Based on the plane features of the keypoints, plane coordinates of the keypoints are determined. Based on the depth features of the keypoints, depth coordinates of the keypoints are determined. Based on the plane coordinates of the keypoints and the depth coordinates of the keypoints, a pose of the region of interest is determined.

In further another aspect, a non-transitory computer storage medium is provided. The computer storage medium stores one or more programs, and the one or more programs can be executed by one or more processors to implement a pose determination method. In particular, plane features of keypoints of a region of interest and depth features of the keypoints are extracted from a depth image. Based on the plane features of the keypoints, plane coordinates of the keypoints are determined. Based on the depth features of the keypoints, depth coordinates of the keypoints are determined. Based on the plane coordinates of the keypoints and the depth coordinates of the keypoints, a pose of the region of interest is determined.

### BRIEF DESCRIPTION OF THE DRAWINGS

FIG. 1 is a schematic diagram of a depth image captured by a TOF camera provided by the embodiments of the disclosure;

FIG. 2 is a schematic diagram illustrating an output result of a probability of hand presence and a hand bounding box provided by the embodiments of the disclosure;

FIG. 3 is a schematic diagram illustrating locations of keypoints on a hand provided by the embodiments of the disclosure;

FIG. 4 is a schematic diagram illustrating an estimation result of a hand pose provided by the embodiments of the disclosure;

FIG. 5 is a schematic diagram illustrating a hand pose detection pipeline provided by the embodiments of the disclosure;

FIG. 6 is a schematic diagram of determining a region of interest with a RoIAlign layer provided by the embodiments of the disclosure;

FIG. 7a is a schematic diagram illustrating a detection window provided by the embodiments of the disclosure;

FIG. 7b is a schematic diagram illustrating a way of determining an Intersection-over-Union provided by the embodiments of the disclosure;

FIG. 8 is a schematic diagram illustrating an architecture of a Pose-REN network provided by the embodiments of the disclosure;

FIG. 9 is a schematic structural diagram of a pose determination apparatus provided by the embodiments of the disclosure;

FIG. 10 is a schematic flowchart of a pose determination method provided by the embodiments of the disclosure;

FIG. 11 is a schematic flowchart of another pose determination method provided by the embodiments of the disclosure;

FIG. 12 is a schematic structural diagram of a feature extractor provided by the embodiments of the disclosure;

FIG. 13 is a schematic flowchart of another pose determination method provided by the embodiments of the disclosure;

FIG. 14a is a schematic diagram illustrating an architecture of a pose determination network provided by the embodiments of the disclosure;

FIG. 14b is a schematic structural diagram of a plane encoder provided by the embodiments of the disclosure;

FIG. 14c is a schematic structural diagram of a depth encoder provided by the embodiments of the disclosure;

FIG. 15 is a schematic flowchart of another pose determination method provided by the embodiments of the disclosure;

FIG. 16 is a schematic diagram illustrating the composition and structure of a pose determination apparatus provided by the embodiments of the disclosure;

FIG. 17 is a schematic diagram illustrating hardware entities of a pose determination device provided by the embodiments of the disclosure; and

FIG. 18 is a schematic structural diagram of a chip provided by the embodiments of the disclosure.

### DETAILED DESCRIPTION OF PREFERRED EMBODIMENTS

The technical solutions of the disclosure will be described in detail below with reference to the accompanying drawings. The following specific embodiments may be combined with each other, and the same or similar concepts or processes may not be repeated in some embodiments.

It should be noted that, in the embodiments of the disclosure, the wordings “first”, “second”, and the like are used to distinguish similar objects, and do not necessarily describe a particular order or sequence.

In addition, the technical solutions described in the embodiments of the disclosure may be combined arbitrarily without conflict.

The ability to accurately and efficiently reconstruct the motion of the human hand from images promises exciting new applications in immersive virtual and augmented realities, robotic control, and sign language recognition. There has been great progress in recent years, especially with the arrival of consumer depth cameras. However, it remains a challenging task due to unconstrained global and local pose variations, frequent occlusion, local self-similarity, and a high degree of articulation.

The pose estimation takes a lot of computational time from the extraction of image features from the raw image to the determination of the hand pose.

Before describing the embodiments of the disclosure, related technologies are introduced first.

The time of flight (TOF) camera is a range imaging camera system that employs time-of-flight techniques to resolve distance between the camera and the subject for each point of the image, by measuring the round trip time of an artificial light signal provided by a laser or an LED. The TOF camera outputs a two-dimensional (2D) image with size of height H×width W, and each pixel value on the 2D image represents a depth value of the object (the pixel value ranges from 0 mm to 3,000 mm). FIG. 1 illustrates a schematic diagram of a depth image captured by the TOF camera provided by the embodiments of the disclosure.

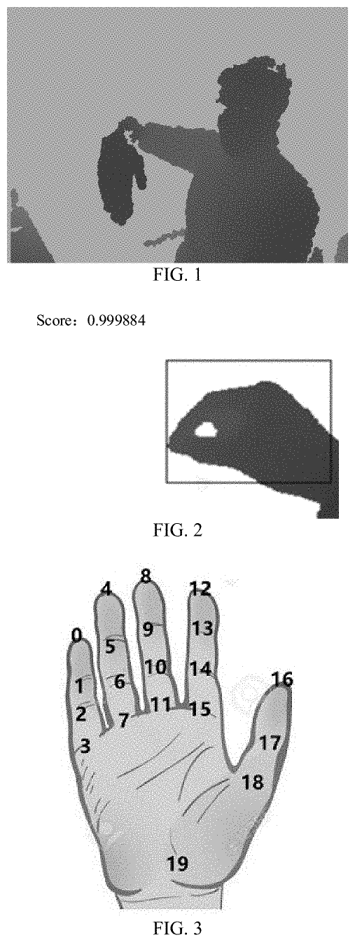

Hand detection is a process of inputting the depth image, and then outputting the probability of hand presence (i.e., a numerical number from 0 to 1, where a larger value represents a larger confidence of hand presence), and a hand bounding box or detection box (i.e., a bounding box representing the location and size of the hand). The score in FIG. 2 is 0.999884, which indicates that the probability of hand presence is 0.999884. The bounding box may be expressed as (xmin, ymin, xmax, ymax). In an embodiment, (xmin, ymin) indicates the upper left corner of the bounding box, and (xmax, ymax) indicates the lower right corner of the bounding box.

The way of 2D hand pose estimation includes: inputting the depth image, and outputting the 2D keypoint locations of the hand skeleton. A schematic diagram illustrating the locations of keypoints on the hand provided by the embodiments of the disclosure is shown in FIG. 3. Each keypoint is indicated by a 2D coordinate (e.g., an x coordinate and a y coordinate, where x is on a horizontal image axis, and y is on a vertical image axis). FIG. 3 shows that there are 20 keypoints on the hand in the embodiments of the disclosure, which are keypoints 0 to 19.

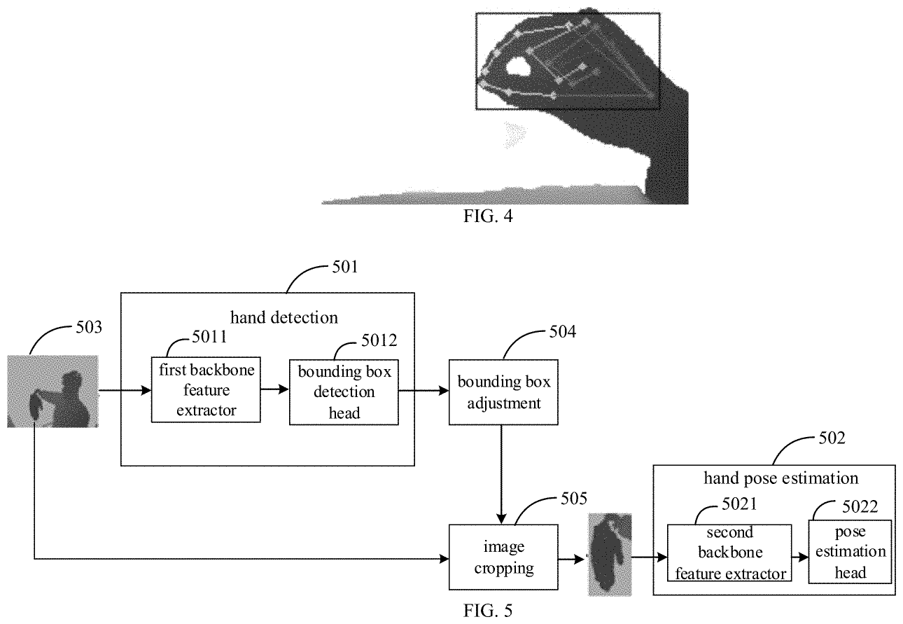

FIG. 4 is a schematic diagram illustrating an estimation result of a hand pose provided by the embodiments of the disclosure. As shown in FIG. 4, the estimation result of the hand pose may be determined based on the locations of the individual 2D keypoints in the depth image.

The way of 3D hand pose estimation includes: inputting the depth image, and outputting the 3D keypoint locations of the hand skeleton. The locations of the hand keypoints are shown in FIG. 3. The location of each keypoint is indicated by a 3D coordinate (e.g., an x coordinate, a y coordinate and a z coordinate, where x is on the horizontal image axis, y is on the vertical image axis, z is on the depth direction). The 3D pose estimation is a hot topic of current research.

The hand pose detection pipeline includes processes of hand detection and hand pose estimation. FIG. 5 is a schematic diagram illustrating a hand pose detection pipeline provided by the embodiments of the disclosure. As shown in FIG. 5, the part of hand detection 501 may be implemented through a first backbone feature extractor 5011 and a bounding box detection head 5012. The part of hand pose estimation 502 may be implemented through a second backbone feature extractor 5021 and a pose estimation head 5022.

First, a depth image may be captured through the TOF camera, and the depth image may be input to the first backbone feature extractor. The first backbone feature extractor may extract some features from the depth image and input the extracted features to the bounding box detection head. The bounding box detection head may determine the bounding box of the hand. The bounding box detection head may be a bounding box detection layer. After the bounding box of the hand is obtained, bounding box adjustment 504 may be performed to obtain an adjusted bounding box. Based on the adjusted bounding box, the depth image is cropped 505 to obtain a cropped image. The cropped image is input to the second backbone feature extractor 5021, and the second backbone feature extractor 5021 may extract some features from the cropped image. The extracted features are input into the pose estimation head 5022, where the pose estimation head 5022 may be a pose estimation layer. The pose estimation layer may estimate the pose of the hand based on the extracted features. In some embodiments, the convolutional layer used by the first backbone feature extractor 5011 for feature extraction may be the same as the convolutional layer used by the second backbone feature extractor 5021 for feature extraction.

The task of hand detection and the task of hand pose estimation are completely separated. To connect the two tasks, the location of the output bounding box is adjusted to the mass center of the pixels inside the bounding boxes, and the size of the bounding box is enlarged a little to include all the hand pixels. The adjusted bounding box is used to crop the raw depth image. The cropped image is fed into the task of hand pose estimation. The duplicated computation is found when the first backbone feature extractor 5011 and the second backbone feature extractor 5021 extract the image features.

A region of interest (ROI) may be determined by using a RoIAlign layer, and the region of interest may be a region corresponding to the cropped image mentioned above.

The RoIAlign layer removes the harsh quantization of RoIPool layer, properly aligning the extracted features with the input. Any quantization of the RoI boundaries or bins may be avoided (i.e., x/16 is used, instead of [x/16]). Bilinear interpolation is used to compute the exact values of the input features at four regularly sampled locations in each RoI bin, and the results are aggregated (using max or average).

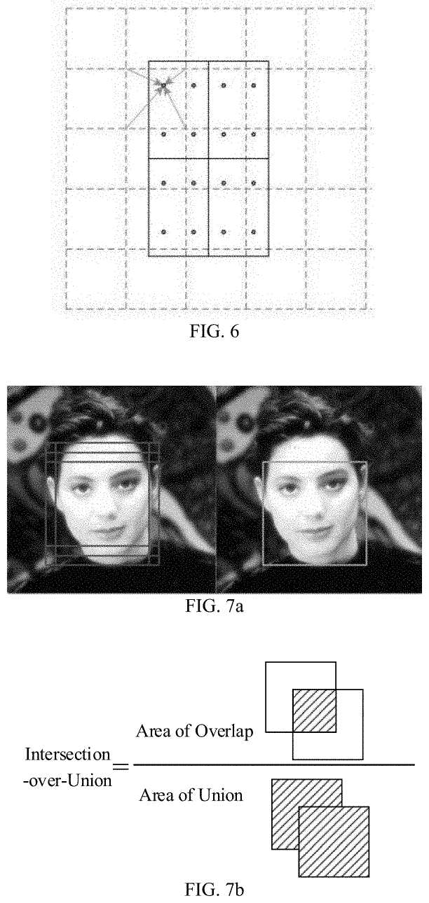

FIG. 6 is a schematic diagram of determining a region of interest with a RoIAlign layer provided by the embodiments of the disclosure. In FIG. 6, the dashed grid represents a feature map, the solid line represents the region of interest RoI (2×2 bins in this example), and there are 4 sampling points in each bin. The RoIAlign layer computes the value of each sampling point by bilinear interpolation from the nearby grid points on the feature map, and any coordinates related to the bin or sampling points are not quantified. The results are not sensitive to the exact sampling locations, or how many points are sampled, as long as no quantization is performed.

Non-Maximum Suppression (NMS) has been widely used in several key aspects of computer vision and is an integral part of many proposed approaches in detection, might it be edge, corner or object detection. Its necessity stems from the imperfect ability of detection algorithms to localize the concept of interest, resulting in groups of several detections near the real location.

In the context of object detection, approaches based on sliding windows typically produce multiple windows with high scores close to the correct location of objects. This is a consequence of the generalization ability of object detectors, the smoothness of the response function and visual correlation of close-by windows. This relatively dense output is generally not satisfying for understanding the content of an image. As a matter of fact, the number of window hypotheses at this step is simply uncorrelated with the real number of objects in the image. The goal of NMS is therefore to retain only one window per group, corresponding to the precise local maximum of the response function, ideally obtaining only one detection per object.

FIG. 7a is a schematic diagram illustrating a detection window provided by the embodiments of the disclosure. As shown in FIG. 7a, the left side of FIG. 7a illustrates detection windows determined by the approaches based on sliding windows. It can be seen that the approaches based on sliding windows may determine multiple detection windows. As shown in FIG. 7b, the right side of FIG. 7b illustrates a detection window determined by the NMS-based method. It can be seen that the NMS-based method can only determine one detection window.

In some embodiments, when the hand detection is performed by the NMS-based method, the one determined detection window may be the region of interest mentioned above.

In the evaluation system of target detection, there is a parameter called Intersection-over-Union (IoU), which is the overlap ratio between the target window generated by the model and the original marking window. It can be simply understood as the ratio of the intersection of the detection result and the Ground Truth to the union of the detection result and the Ground Truth. The Intersection-over-Union may be understood as the detection accuracy.

FIG. 7b is a schematic diagram illustrating a way of determining the Intersection-over-Union provided by the embodiments of the disclosure. The Intersection-over-Union may be obtained as the ratio of the overlapping region (Area of Overlap) to the union region (Area of Union). For example, given two bounding boxes BB1 and BB2, the intersection of BB1 and BB2 (denoted as BB1∩BB2) is defined as the overlapping region of BB1 and BB2, and BB1□BB2 is defined as the union region of BB1 and BB2.

The conversion relationship between UVD coordinates and XYZ coordinates is introduced here.

The relationship between the UVD coordinates and the XYZ coordinates is shown in formula (1) below. (x, y, z) are coordinates in XYZ format, and (u, v, d) are coordinates in UVD format.

$$x = \frac{( u - {C}_{x} ) \times d}{{f}_{x}} , y = \frac{( v - {C}_{y} ) \times d}{{f}_{y}} , z = d \qquad ( 1 )$$

In formula (1), Cₓ represents the x value of a principle point, G represents they value of the principal point, the principal point may be located in the center of the image (which may be the depth image or the cropped image), fₓ represents the focal length in the x direction, and f_{y} represents the focal length in they direction.

Here are some explanations of classification and regression. Classification predictive modeling problems are different from regression predictive modeling problems. Classification is the task of predicting a discrete class label. Regression is the task of predicting a continuous quantity. There is some overlap between the algorithms for classification and regression. For example, a classification algorithm may predict a continuous value, but the continuous value is in the form of a probability for a class label; a regression algorithm may predict a discrete value, but the discrete value is in the form of an integer quantity.

Here are some explanations for Convolutional Neural Networks (CNN). A convolutional neural network consists of an input and an output layer, as well as multiple hidden layers. The hidden layers of a CNN typically consist of a series of convolutional layers that convolve with a multiplication or other dot product. The activation function is commonly a Rectified Linear Unit (ReLU) layer, and is subsequently followed by additional convolutions such as pooling layers, fully connected layers and normalization layers, referred to as hidden layers because their inputs and outputs are masked by the activation function and final convolution. The final convolution, in turn, often involves backpropagation in order to more accurately weight the end product. Though the layers are colloquially referred to as convolutions, this is only by convention. Mathematically, it is technically a sliding dot product or cross-correlation. This has significance for the indices in the matrix, in that it affects how weight is determined at a specific index point.

When programming a CNN, each convolutional layer within a neural network should have the following attributes: the input is a tensor with shape (number of images)×(image width)×(image height)×(image depth); and convolutional kernels' width and height are hyper-parameters, and their depth must be equal to that of the image. Convolutional layers convolve the input and pass its result to the next layer. This is similar to the response of a neuron in the visual cortex to a specific stimulus.

Each convolutional neuron processes data only for its receptive field. Although fully connected feedforward neural networks can be used to learn features as well as classify data, it is not practical to apply this architecture to images. A very high number of neurons would be necessary, even in a shallow (opposite of deep) architecture, due to the very large input sizes associated with images, where each pixel is a relevant variable. For instance, a fully connected layer for a (small) image of size 100×100 has 10,000 weights for each neuron in the second layer. The convolution operation brings a solution to this problem as it reduces the number of free parameters, allowing the network to be deeper with fewer parameters. For instance, regardless of image size, tiling regions of size 5×5, each with the same shared weights, requires only 25 learnable parameters. In this way, it resolves the vanishing or exploding gradients problem in training traditional multi-layer neural networks with many layers by using backpropagation.

Convolutional networks may include local or global pooling layers to streamline the underlying computation. Pooling layers reduce the dimensions of the data by combining the outputs of neuron clusters at one layer into a single neuron in the next layer. Local pooling combines small clusters, typically 2×2. Global pooling acts on all the neurons of the convolutional layer. In addition, pooling may compute a max or an average. Max pooling uses the maximum value from each of a cluster of neurons at the prior layer. Average pooling uses the average value from each of a cluster of neurons at the prior layer.

Fully connected layers connect every neuron in one layer to every neuron in another layer. It is in principle the same as the traditional multi-layer perceptron (MLP) neural network. The flattened matrix goes through a fully connected layer to classify the images.

The pose determination method in the embodiments of the disclosure can be applied to a pose guided structured region ensemble network (Pose-REN).

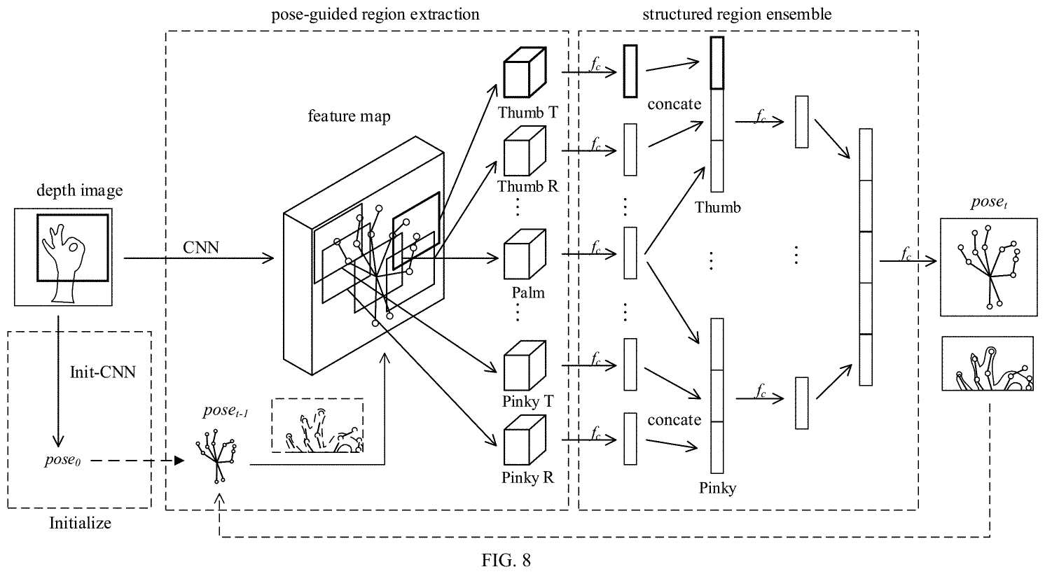

FIG. 8 is a schematic diagram illustrating an architecture of a Pose-REN network provided by the embodiments of the disclosure. As shown in FIG. 8, the Pose-REN network may acquire a depth image and use a simple CNN (Init-CNN) to predict an initial hand pose pose₀ as the initialization (Initialize) of the cascaded framework. Based on pose₀, two parts of pose-guided region extraction and structured region ensemble are used to generate pose poseₜ based on pose poseₜ₋₁, where t is greater than or equal to 1. The estimated poseₜ₋₁ and the depth image are used as input, and the depth image is fed into the CNN to generate feature maps. Feature regions are extracted from the feature maps under the guidance of poseₜ₋₁, and different joint features are hierarchically fused with structural connections. Pose Poseₜ is the refined hand pose obtained through regression.

Hierarchical fusion of different joint features with structural connections may be achieved as follows. Features of multiple grid regions are extracted from the feature map using a rectangular window, and the features of the multiple mesh regions may correspond to pre-set keypoints. For example, the features of the multiple grid regions may include features related to the fingertip (T) of the thumb, to a first knuckle (R) of the thumb, to the palm, to the fingertip (T) of the pinky, and to a first knuckle (R) of the pinky. Then, the features of the multiple grid regions are all fed into multiple fully connected layers f_{c}, where the features of each grid region correspond to one fully connected layer f_{c}. Through the multiple fully connected layers f_{c}, the features of the individual keypoints may be obtained. Then, the features of the individual keypoints related to a same finger are concatenated with a contact function, to obtain the features of each finger. For example, after the features of these grid regions are fed to the fully connected layers f_{c}, the features of the keypoints corresponding to each grid region may be obtained through the fully connected layers f_{c}, where the keypoints may be for example the fingertip of the thumb and the first knuckle of the thumb. Then, the features of these keypoints belonging to a same part are concatenated or fused. For example, the features of the palm are fused and the features of the thumb are fused, the features of the palm are concatenated and the features of the pinky are concatenated, and so on. Thereafter, the obtained features of the five fingers are fed into five fully connected layers f_{c} respectively, to obtain five features, and the five features are concatenated with the contact function to obtain fused features of the joints of the five fingers of the human hand. The fused features of the joints of the five fingers are fed to a fully connected layer f_{c}, and the hand pose poseₜ is regressed through the regression model of the fully connected layer f_{c}. After poseₜ is obtained, it may be assigned to poseₜ₋₁, so that features may be extracted from the feature map based on poseₜ₋₁ when the next prediction is performed.

In the architecture shown in FIG. 8, a simple CNN (Init-CNN) predicts pose₀ as the initialization of the cascaded framework. Feature regions are extracted from the feature maps generated by a CNN under the guidance of poseₜ₋₁ and hierarchically fused using a tree-like structure. Pose₁ is the refined hand pose obtained by the Pose-REN and will be used as the guidance in next stage.

It should be noted that the terms posture and hand pose are interchangeable.

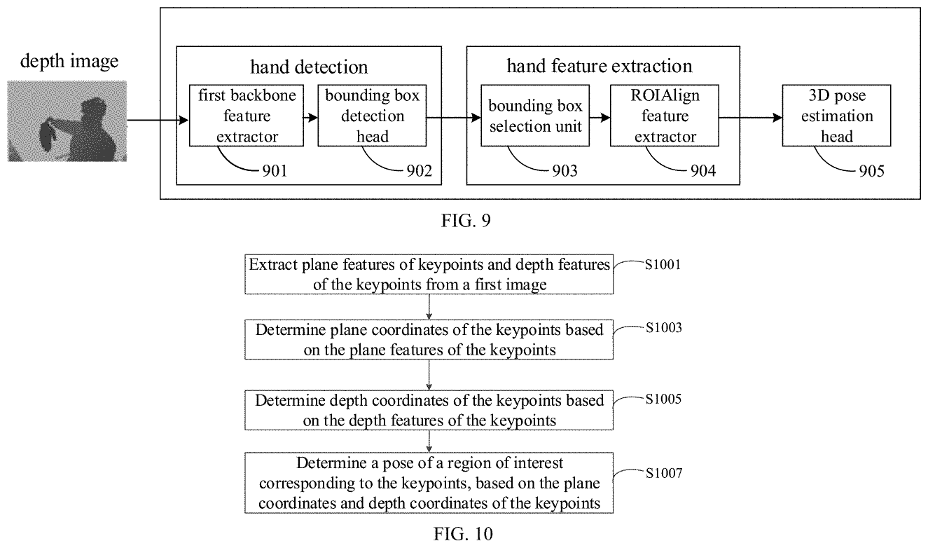

FIG. 9 is a schematic structural diagram of a pose determination apparatus provided by the embodiments of the disclosure. As shown in FIG. 9, the pose determination apparatus includes: a first backbone feature extractor 901, a bounding box detection head 902, a bounding box selection unit 903, a ROIAlign feature extractor 904 and a 3D pose estimation head 905. The first backbone feature extractor 901 may be the same as the first backbone feature extractor 5011 in FIG. 5, the bounding box detection head 902 may be the same as the bounding box detection head 5012 in FIG. 5, and the bounding box selection unit 903 is configured to crop the depth image, to obtain an image surrounded by the bounding box. The ROIAlign feature extractor 904 may be the second backbone feature extractor mentioned above.

In the following, it will describe how to determine a pose based on the acquired depth image in the embodiments of the disclosure.

FIG. 10 is a schematic flowchart of a pose determination method provided by the embodiments of the disclosure. As shown in FIG. 10, the method is implemented by a pose determination device, and the method includes operations as follows.

At S1001, plane features of keypoints and the depth features of the keypoints are extracted from a first image.

The pose determination device may be any device with image processing function. For example, the pose determination device may be a server, a mobile phone, a tablet computer, a notebook computer, a palm computer, a personal digital assistant, a portable media player, a smart speaker, a navigation device, a display device, a wearable device such as smart bracelets, a Virtual Reality (VR) device, an Augmented Reality (AR) device, a pedometer, a digital TV, a desktop computer, a base station, a relay station, an access point, or an in-vehicle device.

The first image is an image including the hand region. In some embodiments, the first image may be a raw image captured by shooting (e.g., the depth image mentioned above). In other embodiments, the first image may be a hand image obtained by cropping the captured raw image for the hand (for example, the image surrounded by the bounding box mentioned above).

The depth image may also be referred to as 3D image. In some embodiments, the pose determination device may include a camera (e.g., a TOF camera), and the depth image is captured by the camera, so that the pose determination device acquires the depth image. In other embodiments, the pose determination device may receive the depth image sent by other devices to acquire the depth image.

The plane features of the keypoints may be plane features of the keypoints on a UV plane in a UVD coordinate system. The plane features may be features located on the UV plane or projected onto the UV plane. The plane features of the keypoints may be deep-level features in the neural network, so that the plane features of the keypoints may be directly input to the first fully connected layer. Accordingly, the first fully connected layer may perform regression on the plane features of the keypoints to obtain UV coordinates of the keypoints. The UV coordinates may be in the form of (u, v, 0).

The depth features of the keypoints may be depth features of the keypoints corresponding to a D axis in the UVD coordinate system. The depth features may be featured projected on the D axis. The depth features of the keypoints may be the deep-level features in the neural network, so that the depth features of the keypoints may be directly input to a second fully connected layer. Thus, the second fully connected layer may perform regression on the depth features of the keypoints, to obtain the D-coordinates of the keypoints (also referred to as the depth coordinates). The D-coordinates may be in the form of (0, 0, d).

The plane features and/or depth features of the keypoints may be features describing each finger, for example, at least one of length, degree of curvature, bent shape, relative position, thickness, and joint location of the finger.

The plane features and/or depth features of the keypoints in the embodiments of the disclosure may be features in a feature map with a width W of 1, a height H of 1, and the number of channels of 128 (1×1×128). In other embodiments, the plane features and/or depth features of the keypoints may be features in other feature map with another width (e.g., any integer from 2 to 7), another height (e.g., any integer from 2 to 7), and another number of channels (e.g., 32, 64, 128, 256, and 512).

In the embodiments of the disclosure, the features of the keypoints (for example, the plane features and the depth features of the keypoints, as well as first features of interest, second features of interest, and third features of interest of the keypoints which will be described below) may be features corresponding to the keypoints, and these features corresponding to the keypoints may be global features or local features. For example, the features corresponding to a keypoint at the fingertip of the thumb may be some features related to the fingertip part or region of the thumb and/or some feature of the whole hand.

The keypoints may include at least one of: the joint of a finger, a fingertip of a finger, the palm root, and the palm center. In the embodiments of the disclosure, the keypoints may include the following 20 points: 3 joints of each of the index finger, middle finger, ring finger and pinky (which are denoted as keypoints 1-3, 5-7, 9-11, and 13-15 shown in FIG. 3); 2 joints of the thumb (which are denoted as keypoints 17 and 18 shown in FIG. 3); the fingertip of each of the five fingers (which are denoted as keypoints 0, 4, 8, 12, and 16 shown in FIG. 3); and the palm root (which is denoted as keypoint 19 shown in FIG. 3). The palm root is located at a part of the palm close to the wrist, and the specific location thereof may refer to the embodiment shown in FIG. 3. In other embodiments, the palm root may also be replaced with the palm center, or the keypoints may include both the palm root and the palm center.

At S1003, plane coordinates of the keypoints are determined based on the plane features of the keypoints.

In some embodiments, the plane features of the keypoints may be input to the first fully connected layer. The first fully connected layer may perform regression on the plane features of the keypoints to obtain the plane coordinates of the keypoints. The first fully connected layer may be a first regression layer or a first regression head for pose estimation. That is, the input of the first fully connected layer is the plane features of the keypoints, and the output of the first fully connected layer is the plane coordinates of the keypoints.

At S1005, depth coordinates of the keypoints are determined based on the depth features of the keypoints.

The operations of S1003 and S1005 in the embodiments of the disclosure may be performed in parallel. In other embodiments, the operations of S1003 and S1005 may be performed sequentially.

In some embodiments, the depth features of the keypoints may be input to the second fully connected layer. The second fully connected layer may perform regression on the depth features of the keypoints to obtain the depth coordinates of the keypoints. The second fully connected layer may be a second regression layer or a second regression head for pose estimation. That is, the input of the second fully connected layer is the depth features of the keypoints, and the output of the second fully connected layer is the depth coordinates of the keypoints.

At S1007, a pose of a region of interest corresponding to the keypoints is determined based on the plane coordinates of the keypoints and the depth coordinates of the keypoints.

In the embodiments of the disclosure, the region of interest may include a hand region. When the first image is a cropped hand image, the region of interest is the same as the first image. When the first image is a captured raw image, the region of interest may be a hand region determined from the raw image. For the way of determining the hand region from the raw image, reference may be made to the description of the embodiment corresponding to FIG. 5. In other embodiments, the region of interest may be other parts of the human body, for example, a face region, a head region, a leg region, or an arm region. The region of interest may also be a certain part of a robot or a certain part of other animals, and any region of interest to which the pose determination method in the embodiments of the disclosure can be applied should fall within the protection scope of the disclosure.

In the embodiments of the disclosure, the pose of the region of interest may be the hand pose. The hand pose may be a pose corresponding to the position coordinates of each of the 20 keypoints listed above. That is, after determining the position coordinates of each keypoint, the pose determination device may determine the pose corresponding to the position coordinates of the individual keypoints. The position coordinates of the keypoints may be UVD coordinates, or may be coordinates in other coordinate systems transformed from the UVD coordinates. In other embodiments, the pose determination device may determine the meaning represented by the hand pose based on the position coordinates of the individual keypoints. For example, the hand pose represents a clenched fist or a V-for-victory sign.

In the embodiments of the disclosure, since the plane features of the keypoints and the depth features of the keypoints are separately extracted from the first image, and the plane coordinates of the keypoints and the depth coordinates of the keypoints are separately determined, the plane features of the keypoints and the depth features of the keypoints do not interfere with each other, thereby improving the accuracy of determining the plane coordinates of the keypoints and the depth coordinates of the keypoints. Moreover, since the plane features of the keypoints and the depth features of the keypoints are extracted, the feature extraction for the determination of the pose of the region of interest is enabled to be simple.

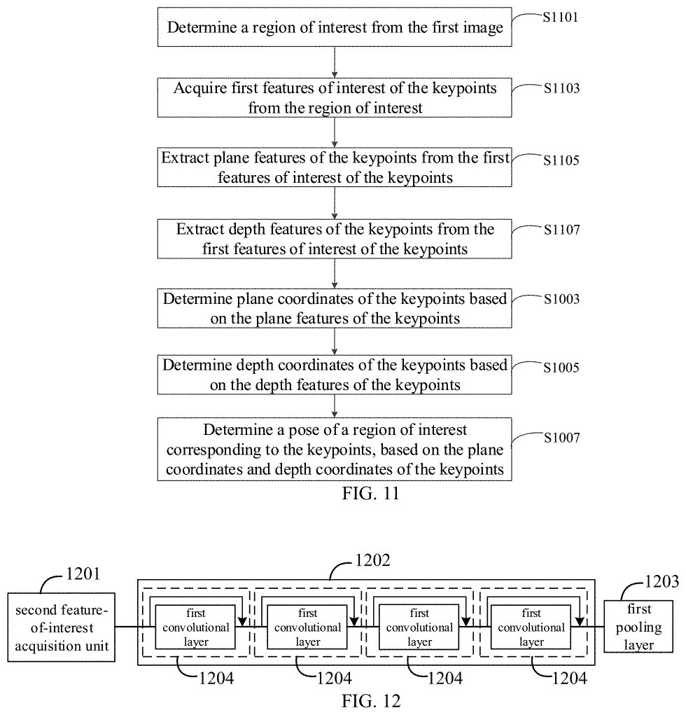

FIG. 11 is a schematic flowchart of another pose determination method provided by the embodiments of the disclosure. As shown in FIG. 11, the method is implemented by the pose determination device. In the method provided by the embodiments of the disclosure, the operation of S1001 may include operations of S1101 to S1107.

At S1101, a region of interest is determined from the first image.

The RoIAlign layer or RoIAlign feature extractor in the pose determination device may determine the region of interest from the first image. After obtaining the first image, the pose determination device may input the first image to the RoIAlign layer, or may make the first image sequentially pass through the first backbone feature extractor, the bounding box detection head, and the bounding box selection unit and reach the RoIAlign feature extractor or RoIAlign layer according to the embodiment corresponding to FIG. 9. The RoIAlign layer outputs the features of the first image, and outputs the region of interest surrounded by a detection box or bounding box. The pose determination device may crop the first image to obtain the region of interest. The RoIAlign layer may send the features in the region of interest bounded by the bounding box to the feature extractor.

At S1103, first features of interest of the keypoints are acquired from the region of interest.

The feature extractor of the pose determination device may extract the first features of interest of the keypoints, from second features of interest in the region of interest.

At S1105, the plane features of the keypoints are extracted from the first features of interest of the keypoints.

A plane encoder (or UV encoder) of the pose determination device may extract the plane features of the keypoints from the first features of interest of the keypoints.

At S1107, the depth features of the keypoints are extracted from the first features of interest of the keypoints.

The operations of S1105 and S1107 in the embodiments of the disclosure may be performed in parallel. In other embodiments, the operations of S1105 and S1107 may be performed sequentially.

A depth encoder of the pose determination device may extract the depth features of the keypoints from the first features of interest of the keypoints.

In some embodiments, S1103 may include operations A1 and A3.

At A1, the second features of interest of the keypoints are acquired, where the second features of interest are of a lower level than the first features of interest.

At A3, the first features of interest are determined based on the second features of interest and a first convolutional layer.

The second features of interest may be features at a relatively shadow level, such as edge, corner, color, texture and other features. The first features of interest may be features at a relatively deep level, such as shape, length, degree of curvature, relative position, and other features.

In some embodiments, the operation of A1 may include operations A11 to A15.

At A11, a first feature map of the region of interest is acquired. The features in the first feature map of the region of interest may be features in the region of interest, or features extracted from the features in the region of interest.

At A13, third features of interest (size of 7×7×256) of the keypoints are extracted from the first feature map, where the third features of interest are of a lower level than the second features of interest.

Alternatively, the second features of interest are more characteristic than the third features of interest.

At A15, the second features of interest are determined based on the third features of interest and a second convolutional layer, where the number of channels of the second convolutional layer is less than the number of channels of the first feature map.

In some embodiments, the operation A3 may include operations A31 and A33.

At A31, the second features of interest are input into a first residual unit, and first specific features are obtained through the first residual unit. The first residual unit includes M first residual blocks connected in sequence, each of the first residual blocks includes the first convolutional layer, and there is a skip connection between an input of the first convolutional layer and an output of the first convolutional layer, where M is greater than or equal to 2.

Each of the first residual blocks is configured to add the features input to this first residual block and features output from this first residual block, and output the result to the next processing stage.

The M first residual blocks in the embodiments of the disclosure are the same residual blocks, and the value of M is 4. In other embodiments, the M first residual blocks may be different residual blocks, and/or M may be in other values, for example, M is 2, 3 or 5. The larger the value of M, the more the features that the first residual unit can extract from the second features of interest, and accordingly the higher the accuracy of the determined hand pose. However, the larger the value of M, the larger the amount of calculation. Thus, the value of M is set as 4, which enables a compromise between the amount of calculation and the accuracy.

At A33, pooling processing is performed on the first specific features to obtain the first features of interest.

The first pooling layer may down-sample a feature map corresponding to the first specific features at least once (for example, down-sample it twice) to obtain the first features of interest.

In the embodiments of the disclosure, the second convolutional layer performs convolution processing on the third features of interest, and the number of channels of the obtained second feature of interest is greatly reduced than the number of channels of the third feature of interest. Therefore, not only the key features in the third features of interest can be retained, but the amount of calculation for obtaining the plane coordinates and the depth coordinates can be greatly reduced. By inputting the second features of interest into the first residual unit to obtain the first specific features, the vanishing gradients problem can be effectively eliminated, and the features of the keypoints can be extracted. Through the pooling processing of the first pooling layer, the amount of computation can be further reduced.

FIG. 12 is a schematic structural diagram of a feature extractor provided by the embodiments of the disclosure. As shown in FIG. 12, the feature extractor includes a second feature-of-interest acquisition unit 1201, a first residual unit 1202, and a first pooling layer 1203.

The input end of the second feature-of-interest acquisition unit 1201 may be connected to the RoIAlign layer, and the RoIAlign layer inputs the third features of interest of the keypoints to the second feature-of-interest acquisition unit 1201. Then, the second feature-of-interest acquisition unit processes the third features of interest of the keypoints, to obtain the second features of interest of the keypoints. The second features of interest of the keypoints are input to the first residual unit 1202.

The first residual unit 1202 may include four first residual blocks 1204, and the first one of the four first residual blocks 1204 receives the second features of interest of the keypoints output from the second feature-of-interest acquisition unit 1201. The first convolutional layer of each first residual block is configured to perform calculation on the input features and output the calculated features. Each first residual block 1204 is configured to add its input features and its output features, and send the added features to the next stage. For example, the first one of the first residual blocks 1204 adds the second features of interest of the keypoints and the convolved features obtained by convolving the second features of interest of keypoints through the first convolutional layer, and it conveys the added features to the second one of the first residual blocks 1204. It should be noted that the fourth one of the four first residual blocks 1204 inputs its addition result to the first pooling layer 1203, and the addition result obtained by the fourth one of the four first residual blocks 1204 in the embodiments of the disclosure is the first specific features.

Continue referring to FIG. 12, the embodiments of the disclosure provide an implementation for obtaining the first feature of interest of a keypoint. The second feature-of-interest acquisition unit 1201 receives the third feature of interest of the keypoint sent from the RoIAlign layer. The size of the third feature of interest of the keypoint is 7×7×256 (the dimension is 7×7, and the number of channels is 256). The second feature-of-interest acquisition unit 1201 convolves the third feature of interest of the keypoint with the second convolutional layer to reduce the number of channels, so as to obtain the second feature of interest of the keypoint. The size of the second convolutional layer is 3×3×128, and the size of the second feature of interest of the keypoint is 7×7×128. The second feature-of-interest acquisition unit 1201 inputs the obtained 7×7×128 second feature of interest to the first residual unit 1202. The first residual unit 1202 processes the second feature of interest, and conveys the obtained first specific feature of size 7×7×128 to the first pooling layer 1203. The first pooling layer 1203 down-samples the first specific feature of size 7×7×128 twice, where a feature of size 5×5×128 is obtained after the first down-sampling, and the first feature of interest of size 3×3×128 is obtained for the keypoint after the second down-sampling.

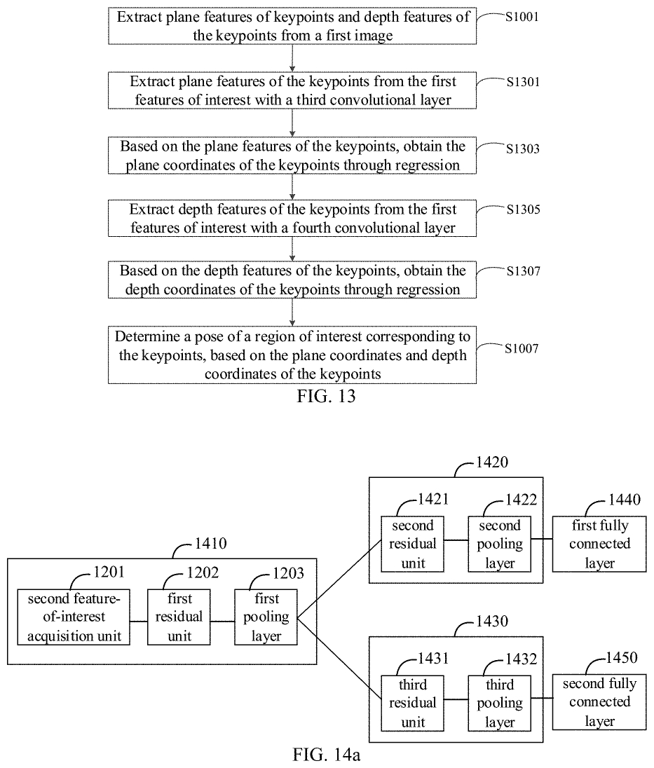

FIG. 13 is a schematic flowchart of another pose determination method provided by the embodiments of the disclosure. As shown in FIG. 13, the method is implemented by the pose determination device. In the method provided by the embodiments of the disclosure, the operation of S1003 may include S1301 and S1303, and the operation of S1005 may include S1305 and S1307.

At S1301, the plane features of the keypoints are extracted from the first features of interest with a third convolutional layer.

The plane encoder may use the third convolutional layer to extract the plane features of the keypoints from the first features of interest. The first regression layer or first pooling layer may input the obtained first features of interest to a second residual unit of the plane encoder.

At S1303, based on the plane features of the keypoints, the plane coordinates of the keypoints are obtained through regression.

In some embodiments, the second pooling layer may input the plane features of the keypoints to the first fully connected layer, so that the first fully connected layer obtains the plane coordinates of the keypoints. The first fully connected layer is configured to obtain the plane coordinates of the keypoints through regression.

At S1305, depth features of the keypoints are extracted from the first features of interest with a fourth convolutional layer. The depth encoder may use the fourth convolutional layer to extract the depth features of the keypoints from the first features of interest. The first pooling layer may input the obtained first features of interest to a third residual unit of the depth encoder.

At S1307, based on the depth features of the keypoints, the depth coordinates of the keypoints are obtained through regression.

In some embodiments, a third pooling layer may input the depth features of the keypoints to the second fully connected layer, so that the second fully connected layer obtains the depth coordinates of the keypoints. The second fully connected layer is configured to obtain the depth coordinates of the keypoints through regression.

In some embodiments, S1301 may include operations B1 and B3.

At B1, the first features of interest are input into the second residual unit, and second specific features are obtained through the second residual unit. The second residual unit includes N second residual blocks connected in sequence, each of the second residual blocks includes the third convolutional layer, and there is a skip connection between an input of the third convolutional layer and an output of the third convolutional layer, where N is greater than or equal to 2.

In the embodiments of the disclosure, the N second residual blocks may be the same residual blocks, and the value of N is 4. In other embodiments, the N second residual blocks may be different residual blocks, and/or N may be in other values.

At B3, pooling processing is performed on the second specific features to obtain the plane features of the keypoints.

The second pooling layer may down-sample a feature map corresponding to the second specific features at least once (e.g., down-sample it twice), thereby obtaining the plane features of the keypoints.

In some embodiments, S1305 may include operations C1 and C3.

At C1, the first features of interest are input into the third residual unit, and third specific features are obtained through the third residual unit. The third residual unit includes P third residual blocks connected in sequence, each of the third residual blocks includes the fourth convolutional layer, and there is a skip connection between an input of the fourth convolutional layer and an output of the fourth convolutional layer, where P is greater than or equal to 2.

In the embodiments of the disclosure, the P third residual blocks may be the same residual blocks, and the value of P is 4. In other embodiments, the P third residual blocks may be different residual blocks, and/or P may be in other values.

At C3, pooling processing is performed on the third specific features to obtain the depth features of the keypoints.

The third pooling layer may down-sample a feature map corresponding to the third specific features at least once (for example, down-sample it twice), thereby obtaining the depth features of the keypoints.

In the embodiments of the disclosure, when the second convolutional layer, the first convolutional layer, and the third or fourth convolutional layer extract features, the extracted features are more and more abstract. The features extracted by the second convolutional layer are at a relatively shallow level. For example, the second convolutional layer extracts at least one of edge features, corner features, color features, and texture features. The level of the features extracted by the first convolutional layer is deeper than the level of the features extracted by the second convolutional layer, and the level of the features extracted by the third or fourth convolutional layer is deeper than the level of the features extracted by the first convolutional layer. For example, the third or fourth convolutional layer extracts at least one of the length, degree of curvature, and shape of the finger.

In the embodiments of the disclosure, the plane features and the depth features are extracted from the first features of interest by the UV encoder and the depth encoder, respectively, and the encoder for obtaining the plane features and the encoder for obtaining the depth features are separated, so that they do not interfere with each other. Moreover, when the plane coordinates/depth coordinates are obtained from the plane features/depth features, the two-dimensional coordinates are easier to be obtained through regression than the three-dimensional coordinates in the related art. Since the second residual unit and the third residual unit are used to process the first features of interest, the vanishing gradients problem can be effectively eliminated, and the features of the keypoints can be extracted. Through the pooling processing of the second and third pooling layers, the amount of computation can be further reduced.

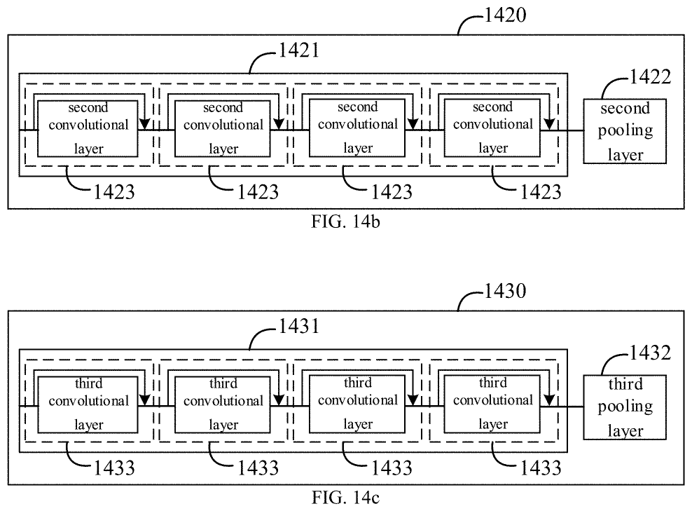

FIG. 14a is a schematic diagram illustrating the architecture of a pose determination network provided by the embodiments of the disclosure. As shown in FIG. 14a, the pose determination network includes a feature extractor 1410, a plane encoder 1420, a depth encoder 1430, a first fully connected layer 1440 and a second fully connected layer 1450.

FIG. 14b is a schematic structural diagram of the plane encoder provided by the embodiments of the disclosure. As shown in FIG. 14a and FIG. 14b, the plane encoder 1420 includes a second residual unit 1421 and a second pooling layer 1422.

The second residual unit 1421 may include four second residual blocks 1423. The process that the four second residual blocks 1423 obtain the plane features based on the first features of interest may be similar to the process that the four first residual blocks shown in FIG. 12 obtain the first features of interest based on the second features of interest, which will not be repeated here.

When the second residual unit 1421 obtains the first feature of interest of the keypoint of size 3×3×128, it may process the first feature of interest, and input its obtained second specific feature of size 3×3×128 into the second pooling layer 1422. The second pooling layer 1422 down-samples the second specific feature of size 3×3×128 twice, where a feature of size 2×2×128 is obtained after the first down-sampling, and the plane feature of the keypoint of size 1×1×128 is obtained after the second down-sampling. The second pooling layer 1422 inputs the obtained plane feature of the keypoint of size 1×1×128 to the first fully connected layer 1440. The first fully connected layer 1440 performs regression on the plane feature of each keypoint to obtain the plane coordinates (or UV coordinates) of each of the 20 keypoints.

FIG. 14c is a schematic structural diagram of the depth encoder provided by the embodiments of the disclosure. As shown in FIG. 14a and FIG. 14c, the depth encoder 1430 includes a third residual unit 1431 and a third pooling layer 1432.

The third residual unit 1431 may include four third residual blocks 1433. The process that the four third residual blocks 1433 obtain the depth features based on the first features of interest may be similar to the process that the four first residual blocks shown in FIG. 12 obtain the first features of interest based on the second features of interest, which will not be repeated here.

When the third residual unit 1421 obtains the first feature of interest of the keypoint of size 3×3×128, it may process the first feature of interest, and input its obtained third specific feature of size 3×3×128 into the third pooling layer 1432. The third pooling layer 1432 down-samples the third specific feature of size 3×3×128 twice, where a feature of size 2×2×128 is obtained after the first down-sampling, and the depth feature of the keypoint of size 1×1×128 is obtained after the second down-sampling. The third pooling layer 1432 inputs the obtained depth feature of the keypoint of size 1×1×128 to the second fully connected layer 1450. The second fully connected layer 1450 performs regression on the depth feature of each keypoint to obtain the depth coordinates (or D-coordinates) of each of the 20 keypoints.

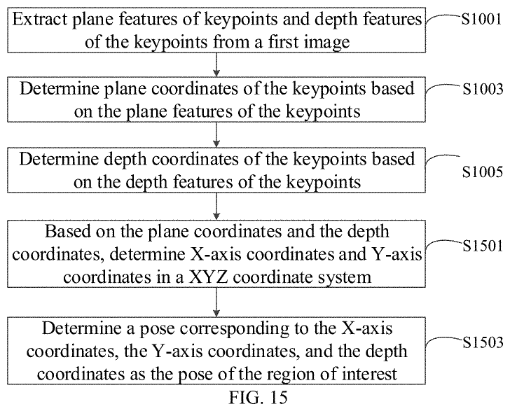

FIG. 15 is a schematic flowchart of another pose determination method provided by the embodiments of the disclosure. As shown in FIG. 15, the method is implemented by the pose determination device. In the method provided by the embodiments of the disclosure, the operation of S1007 may include S1501 and S1503.

At S1501, based on the plane coordinates and the depth coordinates, X-axis coordinates and Y-axis coordinates in a XYZ coordinate system are determined.

The plane coordinates are UV coordinates, and the UV coordinates are coordinates output by the first fully connected layer. The D-coordinates (or depth coordinates) are coordinates output by the second fully connected layer. The U-axis coordinate and the V-axis coordinate may be converted into the X-axis coordinate and Y-axis coordinate through formula (1).

At S1503, a pose corresponding to the X-axis coordinates, the Y-axis coordinates, and the depth coordinates is determined as the pose of the region of interest.

In the embodiments of the disclosure, the UVD coordinates may be converted into XYZ coordinates, so as to obtain the hand pose based on the XYZ coordinates.

In the embodiments, a compact regression head for the task of 3D hand pose estimation is proposed. The regression head starts from the RoI features, which has the focus on the hand region. It is make compact to include two sub-tasks for 3D hand pose estimations: 1) 2D keypoints, i.e., UV coordinates; and 2) depth estimation for UV coordinates. The 3D keypoints, i.e., XYZ coordinates, are recovered by combining UV coordinates and the corresponding depth.

This disclosure also falls into the category of using the fully connect layer as the final layer to regress the coordinates. However, first of all, the embodiments of the disclosure start from the RoI features instead of the raw image; secondly, the architecture of the regression head is different, i.e., the embodiments of the disclosure mainly use convolutional layers instead of the fully connected layer, except for the final regression layer (or fully connected layer). Finally, the embodiments of the disclosure regress the UVD coordinates instead of XYZ coordinates.

In the embodiments of the disclosure, the base feature extractor extracts the keypoints feature on the 7×7×256 (height×width×channel) image feature maps. The image feature maps are firstly applied with 3×3×128 Conv1 (corresponding to the second convolutional layer above) to shrink the channels from 256 to 128 (i.e., to save computation). The obtained 7×7×128 feature maps are convolved with Conv2 (3×3×128) (corresponding to the first convolutional layer above) to further extract the base keypoint features. The Conv2 has a skip connection, to add the input of Conv2 with the output of Conv2. This Conv2 with its skip connection (corresponding to the first residual block above) is repeated for 4 times. After it, the 7×7×128 keypoint feature maps are down-sampled twice to 3×3×128 keypoint feature maps, by the max pooling of kernel 3×3, i.e., Pool1 (the first pooling layer).

The UV encoder extracts the keypoint features, for the UV coordinate regression. The UV encoder inputs the 3×3×128 keypoint feature maps, and the maps are convolved with Conv3 (corresponding to the third convolutional layer above) to output keypoint feature maps of the same size. The skip connection adds the input of Conv3 with the output of Conv3. This Conv3 with the corresponding skip connection (corresponding to the second residual block above) is repeated for 4 times. After it, the 3×3×128 keypoint feature maps are down-sampled twice to 1×1×128 keypoint feature maps, by the max pooling of kernel 3×3, i.e., Pool2 (the second pooling layer).

The fully connected layer FC1 (corresponding to the first fully connected layer above) is used to regress the UV coordinates for the 20 keypoints.

The depth encoder extracts the keypoint features, for depth regression. The depth encoder inputs the 3×3×128 keypoint feature maps, and the maps are convolved with Conv4 (corresponding to the fourth convolutional layer above) to output the same size keypoint feature maps. The skip connection adds the input of Conv4 with the output of Conv4. This Conv4 with the corresponding skip connection (corresponding to the third residual block above) is repeated for 4 times. After it, the 3×3×128 keypoint feature maps are down-sampled twice to 1×1×128 keypoint feature maps, by the max pooling of kernel 3×3, i.e., Pool3 (the third pooling layer).

The fully connected layer FC2 (corresponding to the second fully connected layer above) is used to regress the depth coordinates for the 20 keypoints.

Finally, the UV coordinates and depth coordinates are used to calculate the XYZ coordinates, for obtaining the hand pose.

Based on the foregoing embodiments, the embodiments of the disclosure provide a pose determination apparatus, where the individual units included in the apparatus and the individual modules included in each unit may be implemented by the processor in the pose determination device; of course, they may also be implemented by a specific logic circuit.

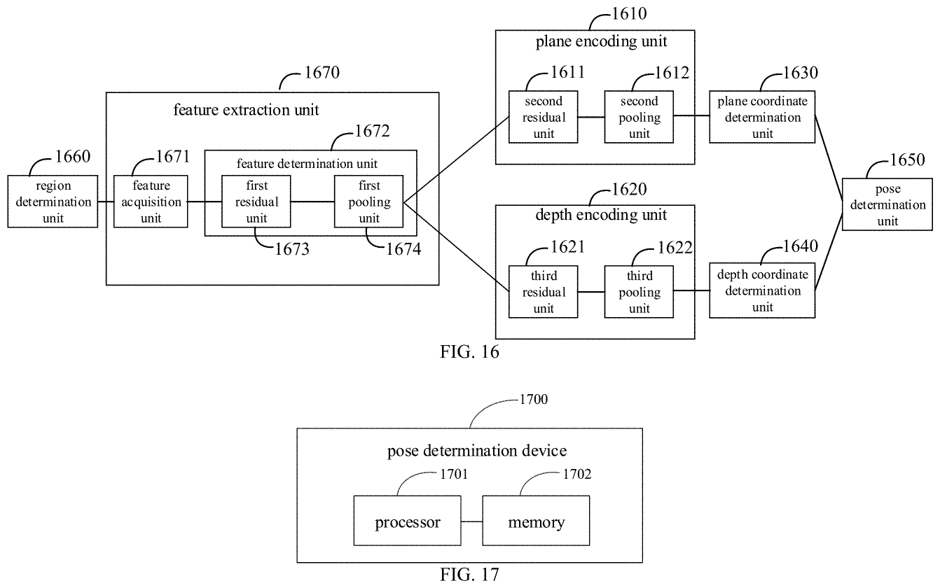

FIG. 16 is a schematic diagram illustrating the composition and structure of a pose determination apparatus provided by the embodiments of the disclosure. As shown in FIG. 16, the pose determination apparatus 1600 includes:

a plane encoding unit 1610, configured to extract, from a first image, plane features of keypoints;

a depth encoding unit 1620, configured to extract, from the first image, depth features of the keypoints;

a plane coordinate determination unit 1630, configured to determine plane coordinates of the keypoints, based on the plane features of the keypoints;

a depth coordinate determination unit 1640, configured to determine depth coordinates of the keypoints, based on the depth features of the keypoints; and

a pose determination unit 1650, configured to determine, based on the plane coordinates of the keypoints and the depth coordinates of the keypoints, a pose of a region of interest corresponding to the keypoints.

The plane encoding unit 1610 may be the plane encoder mentioned above, and the depth encoding unit 1620 may be the depth encoder mentioned above. The plane coordinate determination unit 1630 may be the first fully connected layer mentioned above, and the depth coordinate determination unit 1640 may be the second fully connected layer mentioned above.

In some embodiments, the pose determination apparatus 1600 further includes a region determination unit 1660 and a feature extraction unit 1670.

The region determination unit 1660 is configured to determine the region of interest from the first image.

The feature extraction unit 1670 is configured to acquire first features of interest of the keypoints from the region of interest.

The plane encoding unit 1610 is further configured to extract the plane features of the keypoints from the first features of interest of the keypoints.

The depth encoding unit 1620 is further configured to extract the depth features of the keypoints from the first features of interest of the keypoints.

The region determination unit 1660 may be the RoIAlign layer mentioned above, and the feature extraction unit 1670 may be the feature extractor mentioned above.

In some embodiments, the feature extraction unit 1670 includes a feature acquisition unit 1671 and a feature determination unit 1672.

The feature acquisition unit 1671 is configured to acquire second features of interest of the keypoints, the second features of interest being of a lower level than the first features of interest.

The feature determination unit 1672 is configured to determine the first features of interest, based on the second features of interest and a first convolutional layer.

The feature acquisition unit 1671 may be the second feature-of-interest acquisition unit in the above embodiments.

In some embodiments, the feature determination unit 1672 includes a first residual unit 1673 and a first pooling unit 1674.

The feature acquisition unit 1671 is further configured to input the second features of interest to the first residual unit.

The first residual unit 1673 is configured to process the second features of interest of the keypoints to obtain first specific features. The first residual unit 1673 includes M first residual blocks connected in sequence, each of the first residual blocks includes the first convolutional layer, and there is a skip connection between an input of the first convolutional layer and an output of the first convolutional layer, where M is greater than or equal to 2.

The first pooling unit 1674 is configured to perform pooling processing on the first specific features, to obtain the first features of interest.

The first residual unit 1673 may be the first residual unit 1202 mentioned above. The first pooling unit 1674 may be the first pooling layer 1203 mentioned above.

In some embodiments, the feature acquisition unit 1671 is further configured to: acquire a first feature map of the region of interest; extract third features of interest (size of 7×7×256) of the keypoints from the first feature map, the third features of interest being of a lower level than the second features of interest; and determine, based on the third features of interest and a second convolutional layer, the second features of interest, where the number of channels of the second convolutional layer is smaller than the number of channels of the first feature map.

In some embodiments, the plane encoding unit 1610 is configured to extract, from the first features of interest, the plane features of the keypoints with a third convolutional layer.

The plane coordinate determination unit 1630 is configured to perform regression, based on the plane coordinates of the keypoints, to obtain the plane coordinates of the keypoints.

In some embodiments, the plane encoding unit 1610 includes a second residual unit 1611 and a second pooling unit 1612.

The first pooling unit 1674 is further configured to input the first features of interest to the second residual unit 1611.

The second residual unit 1611 is further configured to process the first features of interest to obtain second specific features. The second residual unit 1611 includes N second residual blocks connected in sequence, each of the second residual blocks includes the third convolutional layer, and there is a skip connection between an input of the third convolutional layer and an output of the third convolutional layer, where N is greater than or equal to 2.

The second pooling unit 1612 is further configured to perform pooling processing on the second specific features to obtain the plane features of the keypoints.

The second residual unit 1611 may be the second residual unit 1421 mentioned above. The second pooling unit 1612 may be the second pooling layer 1422 in the above embodiments.

In some embodiments, the plane coordinate determination unit 1630 is further configured to input the plane features of the keypoints into a first fully connected layer to obtain the plane coordinates of the keypoints, where the first fully connected layer is configured to obtain the plane coordinates of the keypoints through regression.

In some embodiments, the depth encoding unit 1620 is configured to extract, from the first features of interest, the depth features of the keypoints with a fourth convolutional layer.

The depth coordinate determination unit 1640 is configured to perform regression, based on the depth features of the keypoints, to obtain the depth coordinates of the keypoints.

In some embodiments, the depth coding unit 1620 includes a third residual unit 1621 and a third pooling unit 1622.

The first pooling unit 1674 is further configured to input the first features of interest to the third residual unit 1621.

The third residual unit 1621 is configured to process the first features of interest to obtain third specific features. The third residual unit 1621 includes P third residual blocks connected in sequence, each of the third residual blocks includes the fourth convolutional layer, and there is a skip connection between an input of the fourth convolutional layer and an output of the fourth convolutional layer, where P is greater than or equal to 2.

The third residual unit 1621 is configured to perform pooling processing on the third specific features to obtain the depth features of the keypoints.

The third residual unit 1621 may be the third residual unit 1431 mentioned above. The third pooling unit 1622 may be the third pooling layer 1432 in the above embodiments.

In some embodiments, the depth coordinate determination unit 1640 is further configured to input the depth features of the keypoints into a second fully connected layer to obtain the depth coordinates of the keypoints. The second fully connected layer is configured to obtain the depth coordinates of the keypoints through regression.

In some embodiments, the pose determination unit 1650 is further configured to determine, based on the plane coordinates and the depth coordinates, X-axis coordinates and Y-axis coordinates in a XYZ coordinate system; and determine a pose corresponding to the X-axis coordinates, the Y-axis coordinates, and the depth coordinates, as the pose of the region of interest.

In some embodiments, the region of interest includes a hand region.

In some embodiments, the keypoints include at least one of: a joint of a finger, a fingertip of a finger, a palm root, and a palm center.

The descriptions of the above apparatus embodiments are similar to the descriptions of the above method embodiments, and have similar beneficial effects to the method embodiments. For technical details not disclosed in the apparatus embodiments of the disclosure, reference may be made to the descriptions of the method embodiments of the disclosure.

It should be noted that, in the embodiments of the disclosure, when the above pose determination method is implemented in software function modules and sold or used as an independent product, it may also be stored in a computer-readable storage medium. Based on such understanding, a part of the technical solutions of the embodiments of the disclosure, which essentially or substantially contributes to related art, may be embodied in the form of software products. The computer software products are stored in a storage medium and include several instructions to cause a pose determination device to execute all or part of the methods described in the various embodiments of the disclosure. The storage medium includes various media that can store program codes, such as a U disk, a mobile hard disk, a Read Only Memory (ROM), a magnetic disk or an optical disk. As such, the embodiments of the disclosure are not limited to any specific combination of hardware and software.

It should be noted that FIG. 17 is a schematic diagram of a hardware entity of the pose determination device provided by the embodiments of the disclosure. As shown in FIG. 17, the hardware entity of the pose determination device 1700 includes a processor 1701 and a memory 1702. The memory 1702 stores a computer program that can be executed on the processor 1701. When the processor 1701 executes the program, the operations in the method of any of the above-mentioned embodiments are caused to be implemented.

The memory 1702 may store a computer program that can be executed on the processor. The memory 1702 may be configured to store instructions and applications executable by the processor 1701, and may also cache data to-be-processed or has been processed by each module (for example, image data, audio data, voice communication data and video communication data), which may be implemented by flash memory (FLASH) or Random Access Memory (RAM). The processor 1701 and the memory 1702 may be packaged together.

The embodiments of the disclosure provide a non-transitory computer storage medium, where one or more programs are stored in the non-transitory computer storage medium. The one or more programs may be executed by one or more processors to cause the one or more processors to implement the operations in any of the methods mentioned above.

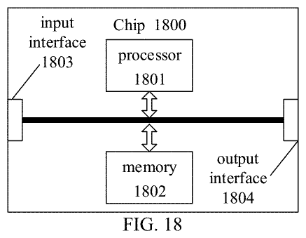

FIG. 18 is a schematic structural diagram of a chip provided by the embodiments of the disclosure. The chip 1800 shown in FIG. 18 includes a processor 1801, and the processor 1801 may call a computer program from the memory, and run the computer program to implement the operations of the method performed by the pose determination device in the embodiments of the disclosure.

In some implementations, as shown in FIG. 18, the chip 1800 may also include memory 1802. The processor 1801 may call the computer program from the memory 1802 and run it to implement the operations of the method performed by the pose determination device in the embodiments of the disclosure.

The memory 1802 may be a separate device independent of the processor 1801, or may be integrated in the processor 1801.

In some implementations, the chip 1800 may also include an input interface 1803. The processor 1801 may control the input interface 1803 to communicate with other devices or chips, to particularly obtain information or data sent from other devices or chips.

In some implementations, the chip 1800 may also include an output interface 1804. The processor 1801 may control the output interface 1804 to communicate with other devices or chips, to particularly output information or data to other devices or chips.

In some implementations, the chip 1800 may be applied to the pose determination device in the embodiments of the disclosure, and the chip 1800 may implement the corresponding processes implemented by the pose determination device in each method of the embodiments of the disclosure, which will not be repeated here for simplicity. The chip 1800 may be a baseband chip in the pose determination device.

It should be understood that the chip 1800 mentioned in the embodiments of the disclosure may also be referred to as a system-on-chip, a system on a chip, a chip system, a Soc, or the like.

The embodiments of the disclosure provide a computer program product, where the computer program product includes a non-transitory computer storage medium. The non-transitory computer storage medium stores computer program codes, and the computer program codes include instructions executable by at least one processor. When being executed by the at least one processor, the instructions cause the at least one processor to implement the operations of the method performed by the pose determination device in the above methods.

In some implementations, the computer program product may be applied to the pose determination device in the embodiments of the disclosure, and the computer program instructions cause a computer to execute the corresponding processes implemented by the pose determination device in the various methods of the embodiments of the disclosure. For simplicity, they will not be repeated here.

It should be understood that the processor in the embodiments of the disclosure may be an integrated circuit chip with signal processing capability. In the implementations, each operation of the above method embodiments may be completed by a hardware integrated logic circuit in the processor or software instructions. The processor may be a general-purpose processor, a Digital Signal Processor (DSP), an Application Specific Integrated Circuit (ASIC), a Field Programmable Gate Array (FPGA) or other available programming logic devices, discrete gate or transistor logic devices, or discrete hardware components, which can implement or execute the methods, operations, and logic block diagrams disclosed in the embodiments of this disclosure. The general-purpose processor may be a microprocessor, or the processor may be any conventional processor or the like. The operations of the methods disclosed in the embodiments of the disclosure may be directly executed by a hardware decoding processor, or executed by a combination of hardware and software modules in the decoding processor. The software modules may be located in random access memory, flash memory, read-only memory, programmable read-only memory or electrically erasable programmable memory, register and other storage media mature in the art. The storage medium is located in the memory, and the processor reads information from the memory, and completes the operations of the above methods in combination with its hardware.

It can be understood that the memory in the embodiments of the disclosure may be a volatile memory or a non-volatile memory, or may include both volatile and non-volatile memories. The non-volatile memory may be a Read-Only Memory (ROM), a Programmable ROM (PROM), an Erasable PROM (EPROM), an Electrically Erasable PROM (EEPROM), or flash memory. The volatile memory may be a Random Access Memory (RAM), which acts as an external cache. By way of illustration and not limitation, many forms of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM) and Direct Rambus RAM (DR RAM). It should be noted that the memory of the systems and methods described herein is intended to include, but not be limited to, these and any other suitable types of memory.

It should be pointed out here that the descriptions of the above embodiments of the pose determination apparatus, device, computer storage medium, chip and computer program product are similar to the descriptions of the above method embodiments, and have similar beneficial effects to the method embodiments. For technical details not disclosed in the embodiments of the storage medium and device of the disclosure, reference may be made to the description of the method embodiments of the disclosure.

It should be understood that references throughout the specification to “one embodiment” or “an embodiment” or “an embodiment of the disclosure” or “the above embodiment” mean that a particular feature, structure or characteristic associated with the embodiment is included in at least one embodiment of the disclosure. Thus, appearances of “in one embodiment” or “in an embodiment” or “an embodiment of the disclosure” or “the above embodiment” in various places throughout the specification do not necessarily refer to the same embodiment. Furthermore, the particular feature, structure or characteristic may be combined in any suitable manner into one or more embodiments. It should be understood that, in various embodiments of the disclosure, the sequence numbers of the above-mentioned processes do not mean the sequence of execution, and the execution sequence of each process should be determined by its functions and internal logic, and which should not constitute any limitation on the embodiments of the disclosure. The above-mentioned serial numbers of the embodiments of the disclosure are only for description, and do not represent the advantages or disadvantages of the embodiments.

Unless otherwise specified, regarding the pose determination device performing any operation in the embodiments of the disclosure, it may mean that the processor of the pose determination device perform the operation. Unless otherwise specified, the embodiments of the disclosure do not limit the sequence in which the pose determination device performs the operations. In addition, the manner of processing the data in different embodiments may be the same or different. It should also be noted that any operation in the embodiments of the disclosure can be independently performed by the pose determination device, that is, the execution of any operation by the pose determination device in the above embodiments may not depend on the execution of other operations.

In several embodiments provided in the disclosure, it should be understood that the disclosed device and method may be implemented in other manners. The device embodiments described above are only illustrative. For example, the division of the units is only in terms of logical functions, and it may also be implemented in other ways in actual implementations. For example, multiple units or components may be combined, or may be integrated into another system; or some features may be ignored, or not implemented. In addition, the coupling, or direct coupling, or communication connection between the components shown or discussed may be implemented through some interfaces, and the indirect coupling or communication connection of the devices or units may be electrical, mechanical or in other forms.

The units described above as separate components may or may not be physically separated, and the components displayed as units may or may not be physical units; they may be located in one place or distributed to multiple network units. Some or all of the units may be selected according to actual needs to achieve the purpose of the solution in the embodiments.

In addition, the individual functional units in the embodiments of the disclosure may all be integrated into one processing unit, or each unit may be independently used as one unit, or two or more units may be integrated into one unit. The above integrated unit may be implemented either in hardware or in combination of hardware and software functional units.

The methods disclosed in the several method embodiments provided in the disclosure can be arbitrarily combined without conflict to obtain new method embodiments.

The features disclosed in the several product embodiments provided in the disclosure can be combined arbitrarily without conflict to obtain new product embodiments.

The features disclosed in several method or device embodiments provided in the disclosure can be combined arbitrarily without conflict to obtain new method embodiments or device embodiments.

Those of ordinary skill in the art can understand that all or part of the operations of implementing the above method embodiments can be completed by hardware related to program instructions. The program may be stored in a computer-readable storage medium, and when the program is executed, the operations of the above method embodiments are caused to be implemented. The storage medium includes: a removable storage device, a Read Only Memory (ROM), a magnetic disk or an optical disk and other media that can store program codes.

Alternatively, if the integrated unit of the disclosure is implemented in software function modules and sold or used as an independent product, it may also be stored in a computer-readable storage medium. Based on such understanding, a part of the technical solutions of the embodiments of the disclosure, which essentially or substantially contributes to related art, may be embodied in the form of software products. The computer software products are stored in a storage medium and include several instructions to cause a computer device (which may be a personal computer, a server, or a network device, etc.) to execute all or part of the methods described in the various embodiments of the disclosure. The storage medium includes various media that can store program codes, such as a removable storage device, a ROM, a magnetic disk, or an optical disk.

In the embodiments of the disclosure, the descriptions of the same operations and the same contents in different embodiments can be referred to each other. In the embodiments of the disclosure, the term “and” has no effect on the sequence of operations. For example, if the pose determination device executes A and B, the pose determination device may execute A first and then execute B, or the pose determination device executes B first and then executes A, or the pose determination device executes B while executing A.

The foregoing is only the embodiments of the disclosure, but the protection scope of the disclosure is not limited thereto. Any variants or replacements, which can be easily conceived by those skilled in the art within the spirit of the technical contents of the disclosure, should fall within the scope of protection of this disclosure. Therefore, the scope of protection of the disclosure should be subject to the protection scope of the claims.

### INDUSTRIAL APPLICABILITY

The embodiments of the disclosure provide the pose determination method, apparatus, and device, storage medium, chip and product, by which the accuracy of determining the plane coordinates of the keypoints and the depth coordinates of the keypoints can be improved, and the feature extraction for the determination of the pose of the region of interest is enabled to be simple.

What is claimed is:

1. A pose determination method, comprising:
extracting, from a first image, plane features of keypoints and depth features of the keypoints;
determining plane coordinates of the keypoints, based on the plane features of the keypoints;
determining depth coordinates of the keypoints, based on the depth features of the keypoints; and
determining, based on the plane coordinates of the keypoints and the depth coordinates of the keypoints, a pose of a region of interest corresponding to the keypoints.

2. The method as claimed in claim 1, wherein the extracting, from the first image, the plane features of keypoints and the depth features of the keypoints comprises:
determining the region of interest from the first image;
acquiring first features of interest of the keypoints from the region of interest;
extracting the plane features of the keypoints from the first features of interest of the keypoints; and
extracting the depth features of the keypoints from the first features of interest of the keypoints.

3. The method as claimed in claim 2, wherein the acquiring first features of interest of the keypoints from the region of interest, comprises:
acquiring second features of interest of the keypoints from the region of interest, the second features of interest being of a lower level than the first features of interest; and
determining the first features of interest, based on the second features of interest and a first convolutional layer.

4. The method as claimed in claim 3, wherein the determining the first features of interest based on the second features of interest and the first convolutional layer, comprises:
inputting the second features of interest to a first residual unit, and obtaining first specific features through the first residual unit, wherein the first residual unit comprises M first residual blocks connected in sequence, each of the first residual blocks comprises the first convolutional layer, and there is a skip connection between an input of the first convolutional layer and an output of the first convolutional layer, where M is greater than or equal to 2; and
performing pooling processing on the first specific features, to obtain the first features of interest.

5. The method as claimed in claim 3, wherein the acquiring second features of interest of the keypoints from the region of interest, comprises:
acquiring a first feature map of the region of interest;
extracting, from the first feature map, third features of interest of the keypoints, the third features of interest being of a lower level than the second features of interest; and
determining, based on the third features of interest and a second convolutional layer, the second features of interest, a number of channels of the second convolutional layer being smaller than a number of channels of the first feature map.

6. The method as claimed in claim 2, wherein the determining plane coordinates of the keypoints based on the plane features of the keypoints, comprises:
extracting, from the first features of interest, the plane features of the keypoints with a third convolutional layer; and
performing regression, based on the plane features of the keypoints, to obtain the plane coordinates of the keypoints.

7. The method as claimed in claim 6, wherein the extracting, from the first features of interest, the plane features of the keypoints with a third convolutional layer, comprises:
inputting the first features of interest to a second residual unit, and obtaining second specific features through the second residual unit, wherein the second residual unit comprises N second residual blocks connected in sequence, each of the second residual blocks comprises the third convolutional layer, and there is a skip connection between an input of the third convolutional layer and an output of the third convolutional layer, where N is greater than or equal to 2; and
performing pooling processing on the second specific features to obtain the plane features of the keypoints.

8. The method as claimed in claim 6, wherein the performing regression, based on the plane features of the keypoints, to obtain the plane coordinates of the keypoints, comprises:
inputting the plane features of the keypoints into a first fully connected layer, to obtain the plane coordinates of the keypoints, wherein the first fully connected layer is configured to obtain the plane coordinates of the keypoints through regression.

9. The method as claimed in claim 2, wherein the determining depth coordinates of the keypoints based on the depth features of the keypoints, comprises:
extracting, from the first features of interest, the depth features of the keypoints with a fourth convolutional layer; and
performing regression, based on the depth features of the keypoints, to obtain the depth coordinates of the keypoints.

10. The method as claimed in claim 9, wherein the extracting, from the first features of interest, the depth features of the keypoints with the fourth convolutional layer, comprises:
inputting the first features of interest into a third residual unit, and obtaining third specific features through the third residual unit, wherein the third residual unit comprises P third residual blocks connected in sequence, each of the third residual blocks comprises the fourth convolutional layer, and there is a skip connection between an input of the fourth convolutional layer and an output of the fourth convolutional layer, where P is greater than or equal to 2; and
performing pooling processing on the third specific features to obtain the depth features of the keypoints.

11. The method as claimed in claim 9, wherein the performing regression, based on the depth features of the keypoints, to obtain the depth coordinates of the keypoints, comprises:
inputting the depth features of the keypoints to a second fully connected layer, to obtain the depth coordinates of the keypoints, wherein the second fully connected layer is configured to obtain the depth coordinates of the keypoints through regression.

12. The method as claimed in claim 1, wherein the determining, based on the plane coordinates of the keypoints and the depth coordinates of the keypoints, the pose of the region of interest corresponding to the keypoints, comprises:
determining, based on the plane coordinates and the depth coordinates, X-axis coordinates and Y-axis coordinates in a XYZ coordinate system; and
determining a pose corresponding to the X-axis coordinates, the Y-axis coordinates, and the depth coordinates, as the pose of the region of interest.

13. The method as claimed in claim 1, wherein the region of interest comprises a hand region.

14. The method as claimed in claim 1, wherein the keypoints comprise at least one of: a joint of a finger, a fingertip of a finger, a palm root, and a palm center.

15. The method as claimed in claim 13, wherein the first image is a raw depth image captured by a time-of-flight camera, or a hand image obtained by cropping the raw depth image for hand.

16. The method as claimed in claim 4, wherein the performing pooling processing on the first specific features to obtain the first features of interest, comprises:
down-sampling, by a first polling layer, a feature map corresponding to the first specific features at least once, to obtain the first features of interest.

17. The method as claimed in claim 7, wherein the performing pooling processing on the second specific features to obtain the plane features of the keypoints, comprises:
down-sampling, by a second pooling layer, a feature map corresponding to the second specific features at least once, to obtain the plane features of the keypoints.

18. The method as claimed in claim 10, wherein the performing pooling processing on the third specific features to obtain the depth features of the keypoints, comprises:
down-sampling, by a third pooling layer, a feature map corresponding to the third specific features at least once, to obtain the depth features of the keypoints.

19. A pose determination device, comprising:
a memory and a processor,
wherein the memory stores a computer program executable on the processor, and
when executing the program, the processor is caused to implement a pose determination method comprising:
determining a region of interest from a depth image;
extracting, from the region of interest, plane features of keypoints and depth features of the keypoints;
determining plane coordinates of the keypoints, based on the plane features of the keypoints;
determining depth coordinates of the keypoints, based on the depth features of the keypoints; and
determining, based on the plane coordinates of the keypoints and the depth coordinates of the keypoints, a pose of the region of interest.

20. A non-transitory computer storage medium, wherein the non-transitory computer storage medium stores one or more programs, and the one or more programs can be executed by one or more processors to implement a pose determination method comprising:
extracting, from a depth image, plane features of keypoints of a region of interest and depth features of the keypoints;
determining plane coordinates of the keypoints, based on the plane features of the keypoints;
determining depth coordinates of the keypoints, based on the depth features of the keypoints; and
determining a pose of the region of interest, based on the plane coordinates of the keypoints and the depth coordinates of the keypoints.
